(19) United States
(12) Patent Application Publication
(10) Pub. No.: US 2011/0259849 A1
(43) Pub. Date: Oct. 27, 2011

(54) METHOD FOR PRODUCING IMPRINT MOLD AND MAGNETIC RECORDING MEDIUM

(75) Inventors: Masatoshi Sakurai, Tokyo (JP); Naoko Kihara, Kawasaki-shi (JP); Hiroki Tanaka, Onojo-shi (JP); Ryosuke Yamamoto, Kawasaki-shi (JP); Akiko Yuzawa, Yokohama-shi (JP)

(73) Assignee: Kabushiki Kaisha Toshiba, Tokyo (JP)

(21) Appl. No.: 13/093,507

(22) Filed: Apr. 25, 2011

(30) Foreign Application Priority Data
Apr. 27, 2010 (JP) 2010-102573

(51) Int. Cl. B29C 33/38; B44C 1/22

(52) U.S. Cl. 216/22; 264/219

(57) ABSTRACT

According to one embodiment, a method for producing an imprint mold includes forming, on a substrate, a plurality of guides including a first wall surface and a second wall surface, wherein an angle between at least one of the first and second wall surfaces and an exposed substrate surface is 131° or less, applying a self-assembling material, which forms a sphere when phase-separated, to a guide groove area defined by the first wall surface, the second wall surface and the substrate surface, and self-assembling the self-assembling material to form a dot pattern, etching the substrate by using the dot pattern as a mask to transfer the dot pattern and forming an imprint mold by using the substrate with the dot pattern transferred as a master mold.

### CROSS-REFERENCE TO RELATED APPLICATIONS

This application is based upon and claims the benefit of priority from Japanese Patent Application No. 2010-102573, filed Apr. 27, 2010; the entire contents of which are incorporated herein by reference.

### FIELD

Embodiments described herein relate generally to a method for producing an imprint mold and a method for producing a magnetic recording medium.

### BACKGROUND

With a view to achieving a higher capacity of a magnetic recording apparatus like a hard disk, the increase in recording density of a magnetic recording medium included in such a magnetic recording apparatus has been intended. Bit patterned media (BPM) is a type of magnetic recording medium developed for such a purpose. In the BPM, a single magnetic dot functions as a single recording unit. When this magnetic dot exists while shifting from an assumed position, an exact access of a read/write head to the magnetic dot is hindered, which consequently leads to an error of writing and reading. Accordingly, in terms of the BPM performance, it is important that these magnetic dots are exactly arrayed.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIGS. 1A, 1B, 1C, 1D, 1E and 1F are cross-sectional views each showing a method for producing a first guide stamper according to a first embodiment;

FIGS. 2A, 2B, 2C, 2D, 2E, 2F, 2G and 2H are cross-sectional views each showing a method for producing an imprint mold and a magnetic recording medium according to the first embodiment;

FIGS. 3A, 3B, 3C and 3D are cross-sectional views each showing a positional relation between a guide and a sphere in the embodiment;

FIGS. 4A, 4B and 4C are cross-sectional views each showing a relation between an angle of a wall surface of the guide and a state of the sphere to be formed;

FIGS. 5A, 5B, 5C, 5D, 5E, 5F and 5G are cross-sectional views each showing a method for producing a second guide stamper according to a second embodiment;

FIGS. 6A, 6B, 6C, 6D, 6E, 6F, 6G and 6H are cross-sectional views each showing a method for producing an imprint mold and a magnetic recording medium according to the second embodiment; and

FIG. 7 is a graph showing a relation between an angle of a wall surface of the guide and a state of the sphere to be formed.

### DETAILED DESCRIPTION

Various embodiments will be described hereinafter with reference to the accompanying drawings.

In general, according to one embodiment, there is provided a method for producing an imprint mold, comprising forming, on a substrate, a plurality of guides comprising a first wall surface and a second wall surface, wherein an angle between at least one of the first and second wall surfaces and an exposed substrate surface is 131° or less, applying a self-assembling material, which forms a sphere when phase-separated, to a guide groove area defined by the first wall surface, the second wall surface and the substrate surface, and self-assembling the self-assembling material to form a dot pattern, etching the substrate by using the dot pattern as a mask to transfer the dot pattern and forming an imprint mold by using the substrate with the dot pattern transferred as a master mold.

<Method for Producing Imprint Mold>

A method for producing an imprint mold according to a first embodiment will be described below.

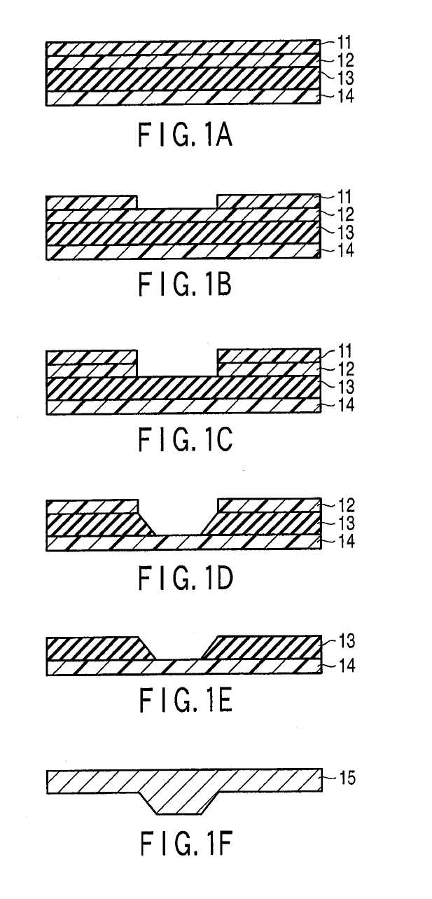

First, based on FIGS. 1A to 1F, a method for producing a first guide stamper 15 used in the method for producing the imprint mold according to the first embodiment will be described.

As shown in FIG. 1A, a sputter carbon layer 13 and a silicon mask 12 are sputtered on a silicon substrate 14 in this order to thereafter apply an electron beam resist 11.

As shown in FIG. 1B, part of the electron beam resist 11 is removed by electron beam drawing and development to form a pattern of protrusions and recesses. This pattern comprises an area corresponding to a guide and an area corresponding to a groove between the guides.

As shown in FIG. 1C, the silicon mask 12 is etched by using the electron beam resist 11 with the pattern of protrusions and recesses formed as a mask to expose the sputter carbon layer 13 in the area of recesses. At this time, CF₄ is used as an etching gas.

As shown in FIG. 1D, the sputter carbon layer 13 is etched by using the silicon mask 12 with the pattern of protrusions and recesses formed as a mask. Ar is used as an ion milling gas. At this time, the recess of the sputter carbon layer 13 is etched while tapered. That is to say, the recess is formed so as to narrow downward. In FIG. 1D, an angle between a wall surface of the sputter carbon layer 13 and an exposed surface of the silicon substrate 14 is an obtuse angle. In the first embodiment, this angle is approximately the same on either side of the recess of the sputter carbon layer 13.

As shown in FIG. 1E, the silicon mask 12 remaining on the protrusion of the sputter carbon layer 13 is removed by etching with the use of CF₄ gas.

As shown in FIG. 1F, electroforming in which the pattern of protrusions and recesses of the sputter carbon layer 13 is used as a mold is performed to form the first guide stamper 15. This first guide stamper 15 has the pattern of protrusions and recesses corresponding to those of the sputter carbon layer 13 used as the mold. Accordingly, a taper of a protrusion of the first guide stamper 15 is at approximately the same angle on either side.

As described above, the first guide stamper 15 according to the first embodiment is formed.

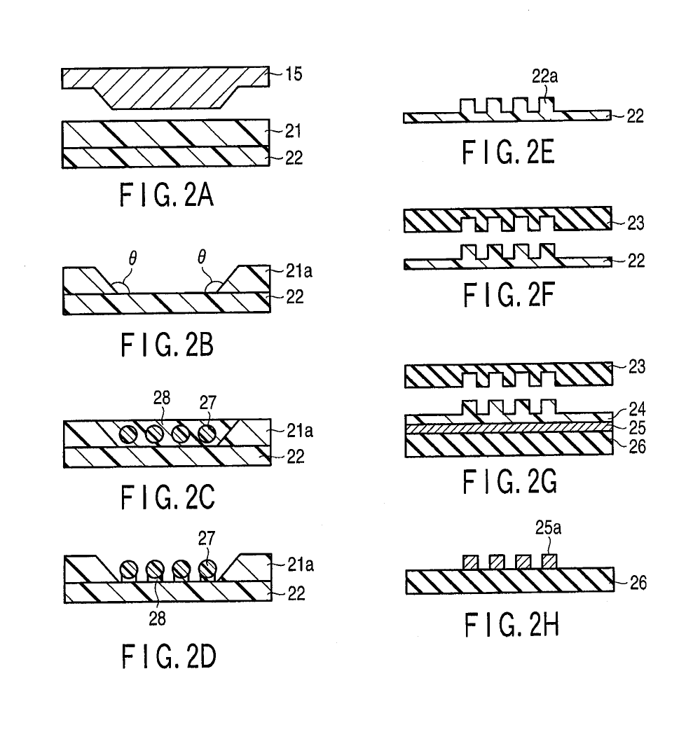

Next, based on FIGS. 2A to 2H, the method for producing an imprint mold 23 according to the first embodiment, in which the first guide stamper 15 is utilized, will be described.

As shown in FIG. 2A, an imprint resist 21 is applied on a silicon substrate 22. Next, the pattern of protrusions and recesses of the first guide stamper 15 produced as described above is imprinted on the imprint resist 21. That is to say, a face having the pattern of protrusions and recesses of the first guide stamper 15 is pressed against a surface of the imprint resist 21.

As shown in FIG. 2B, the pressed first guide stamper 15 is removed. At this time, though not shown in FIG. 2B, a residual layer of the imprint resist 21 remains on a bottom face of a recess formed in the imprint resist 21. This residual layer is removed by etching to expose a surface of the silicon substrate 22 in the recess, so that the imprint resist 21 is segmented to form a guide 21a. This guide 21a has a shape corresponding to the first guide stamper 15. That is to say, an angle θ between a wall surface of the guide 21a and an exposed surface of the silicon substrate is an obtuse angle. Specifically, θ is 131° or less, preferably θ is 120° or more and 131° or less.

Here, in considering the single guide 21a, this guide 21a includes the other wall surface (a second wall surface) on the opposite side of one wall surface (a first wall surface). In considering the two guides 21a arranged side by side, a wall surface (a first wall surface) of one guide 21a is opposite to a wall surface (a second wall surface) of the other guide 21a. Thus, it is understood that an expression “the guide 21a includes the first wall surface and the second wall surface” includes both the case of assuming the single guide 21a and the case of assuming the two guides 21a arranged side by side. As shown in FIG. 2B, in the producing method according to the first embodiment, an angle between the exposed surface of the silicon substrate 22 and the first wall surface of the guide 21a is approximately the same as an angle between the exposed surface of the silicon substrate 22 and the second wall surface of the guide 21a.

A grooved area defined by the wall surfaces of the two guides 21a arranged side by side and the exposed surface of the silicon substrate 22 may be expressed as “a guide groove area”.

As shown in FIG. 2C, a self-assembling material is applied in the guide groove area and phase-separated into a sphere 27 and a matrix 28 by subsequently inducing self organization. These processes are performed, for example, in such a manner that polystyrene-polydimethylsiloxane diblock copolymer (PS-PDMS) (molecular weight of PS: 11700, molecular weight of PDMS: 2900) solution is applied in the guide groove area by spin coating and then phase-separated into PDMS (the sphere 27) and PS (the matrix 28) by annealing at a temperature of 180° C. A material to form a sphere (a globe) by phase-separation other than PS-PDMS may also be used as the self-assembling material. In these processes, the sphere 27 is formed in a regular array while separated at even intervals, preferably into a layer.

As shown in FIGS. 2D and 2E, the silicon substrate 22 is etched by using the sphere 27 formed by phase separation as a mask. At this time, for example, CF₄ is used as an etching gas. The spheres 27 are arrayed while having a regular dot pattern at even intervals, so that silicon substrate dots 22a arrayed with a regular dot pattern at even intervals may be formed on the silicon substrate 22 by etching with the use of the sphere 27 as a mask.

As shown in FIG. 2F, the imprint mold 23 is formed by electroforming in which the silicon substrate 22 with the dot pattern formed is used as a mold. Thus, an exact dot pattern comprising a multitude of dotted recesses is formed in the imprint mold 23.

As described above, the imprint mold 23 according to the first embodiment is formed.

The angle of the taper of the protrusion of the first guide stamper 15 as shown in FIG. 2A does not exactly need to correspond to the angle θ of the guide 21a. The angle θ may be formed in the guide 21a at a stage of finishing a process as shown in FIG. 2B. Accordingly, if finally capable of achieving the angle θ of the guide 21a, the angle of the taper of the protrusion of the first guide stamper 15 and the angle between the wall surface of the recess of the sputter carbon layer 13 and the surface of the silicon substrate 14 as shown in FIG. 1D are not limited.

A process of forming the guide 21a on the silicon substrate 22 as shown in FIG. 2B is not limited to the case of utilizing the first guide stamper 15. For example, after forming an approximately rectangular recess in the imprint resist 21, the angle of θ may be achieved by engraving the wall surface with milling. In addition, a technique capable of forming the angle θ may be utilized.

<Method for Producing Magnetic Recording Medium>

Based on FIGS. 2G and 2H, a method for producing a magnetic recording medium according to the embodiment, in which the imprint mold 23 is utilized, will be described below.

First, as shown in FIG. 2G, a magnetic recording layer 25 is formed on a glass substrate 26 to apply an imprint resist 24 thereon.

Next, the dot pattern of the imprint mold 23 produced as described above is imprinted on this laminate. The dot pattern is formed on the imprint resist 24 by pressing a face having the dot pattern of the imprint mold 23 against the imprint resist 24 of the laminate.

As shown in FIG. 2H, the magnetic recording layer 25 is subjected to milling processing by using the imprint resist with the dot pattern formed as a milling mask. Thus, a magnetic dot comprising an exactly desired pattern is formed on the glass substrate 26.

Thereafter, the magnetic recording medium having the regular magnetic dot pattern may be produced by properly performing embedding of a non-magnetic substance and formation of a protective film.

<Regarding Angle of Wall Surface of Guide>

A relation between the angle of the guide wall surface and the dot pattern formed by the self-assembling material will be described below.

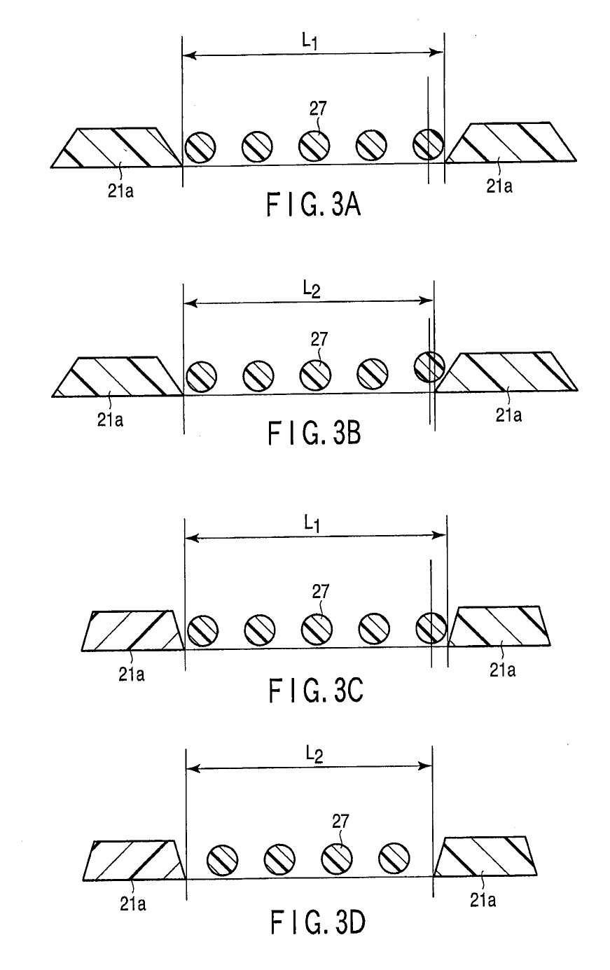

FIGS. 3A and 3B are cross-sectional views showing the two guides 21a arranged side by side and the sphere 27 formed therebetween in the producing method according to the embodiment. In these FIGS. 3A and 3B, in order to show a positional relation between the sphere and the guides, the matrix 28 in FIGS. 2C and 2D is omitted.

As shown in FIGS. 3A to 3D, in the producing method according to the embodiment, the angle θ between the wall surface of the guides 21a and the surface of the silicon substrate 22 is 131° or less, preferably 120° or more and 131° or less. FIG. 3A shows the case where a width of the guide groove between the two guides 21a arranged side by side is the most appropriate for an array of the sphere 27. As shown in FIG. 3B, even in the case where the width of the guide groove becomes narrower than an optimum value, the sphere 27 is stably formed in a state of running on the inclined wall surface of the guides 21a. Thus, the whole array of the sphere 27 is also made into an assumed pattern. The use of the guides 21a according to the embodiment allows the imprint mold 23 and the magnetic recording medium, in which the assumed dot pattern is exactly reproduced, to be produced even in the case where a size and a shape of the guides 21a are disordered. FIGS. 3A and 3B signify the case where the width of the guide groove is wide and narrow respectively, based on L₁>L₂ with regard to an edge distance of each of the guides 21a.

FIGS. 3C and 3D show the case where the tilt angle θ of the guides is less than 120°. In the case of L₁>L₂ with regard to the edge distance of the guides 21a, a pitch between the spheres 27 narrows, or as shown in FIG. 3D, the number of the spheres arrayed in the guides becomes less than the case of being arrayed at the proper pitch therebetween, and the desired pattern is not obtained resulting in a defect.

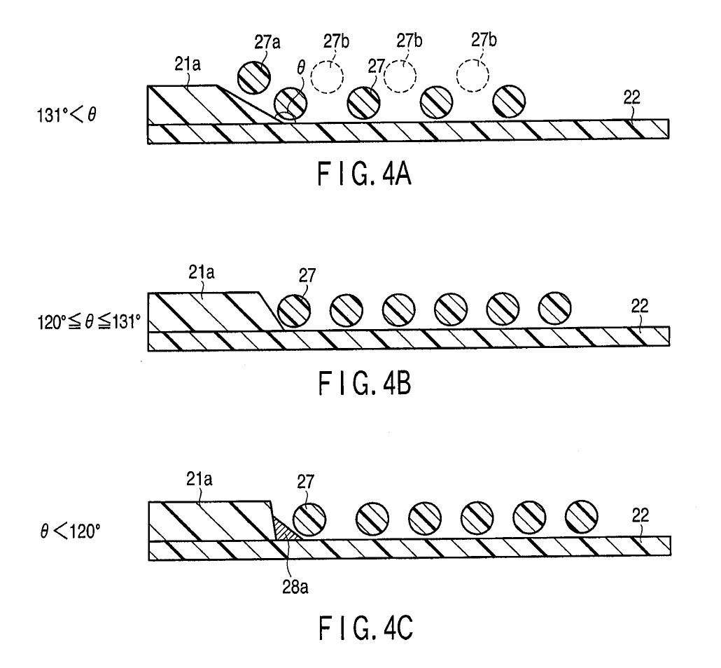

Next, based on FIGS. 4A to 4C, the angle θ between the wall surface of the guides 21a and the surface of the silicon substrate 22 will be described. In these FIGS. 4A to 4C, in order to show a positional relation between the sphere and the guides, the matrix 28 in FIGS. 2C and 2D is omitted.

In the embodiment, this angle θ is 131° or less. This condition, as shown in FIG. 4B, may restrain the sphere 27 from being formed on the guide 21a. FIG. 4A shows the case where 9 is more than 131° and a sphere 27a is formed on the guide 21a. The reason therefor is that 9 is so large that the sphere 27a is at the same position as a second-layer sphere 27b of a self-assembling pattern virtually shown in FIG. 4A and no energy loss is caused even though the sphere is formed from the guide groove onto the guide 21a. In other words, this is because, in the case where an inclination of the guide 21a is small (θ is large), the sphere 27a is stably formed on the inclination.

The fact that the angle at a boundary between the case where the sphere 27a is formed on the guide 21a and the case where it is not formed is 131° may be derived as follows.

The energy of the two spheres 27 formed along the wall surface of the guide 21a is most stable in the case where these are in a relation of a hexagonal lattice. That is to say, in the case where the angle θ of the wall surface of the guide 21a is an angle capable of forming such a hexagonal lattice, the sphere 27a is stably formed on the guide 21a. On the other hand, a smaller angle than this angle prevents stable formation of the hexagonal lattice. That is to say, the angle θ as the boundary is an angle capable of forming the hexagonal lattice.

In FIG. 4A, when the layer of the sphere 27 formed directly on the silicon substrate 22 is considered as a first layer, the sphere 27a on the guide 21a is formed as a second layer. The angle θ of the wall surface of the guide 21a is reflected in a positional relation between the sphere 27 of the first layer and the sphere 27a of the second layer, so that the angle θ capable of forming the hexagonal lattice is obtained by considering the relation between the sphere 27 of the first layer and the sphere 27a of the second layer in the hexagonal lattice. That is to say, an expression of tan(180°−θ)=2/√3 may be introduced and θ is an angle slightly larger than 131°. Accordingly, the case where θ is 131° or less may restrain the sphere 27 from being formed on the guide 21a.

In addition, in the embodiment, the angle θ is preferably 120° or more. This condition, as shown in FIG. 4B, allows the pitch between the spheres 27 to be even. FIG. 4C shows the case where θ is less than 120°, and the matrix component in a portion shown by a reference numeral 28a easily becomes sparse in a guide corner section of the sphere 27 closest to the guide 21a. Thus, a distortion occurs in the array of the sphere 27 in the vicinity of the guide. This distortion causes unevenness of the pitch. On the other hand, the case where the angle of the corner is 120° minimizes the occurrence of the distortion of the sphere 27. Accordingly, the case where θ is 120° or more allows the pitch between the spheres 27 to be even.

In the specification, the dot pitch between the spheres 27, between the silicon substrate dots 22a and between the magnetic dots 25a signifies a distance between centers of the spheres or the dots in any case.

The angle θ between the wall surface of the guides 21a and the surface of the silicon substrate 22 may be measured by a known method; for example, the angle θ may be measured by observing a cross section with the use of a scanning electron microscope (SEM).

### MODIFICATION EXAMPLE

The method for producing the imprint mold and the method for producing the magnetic recording medium according to the embodiment are not limited to the first embodiment and may assume a second embodiment described below.

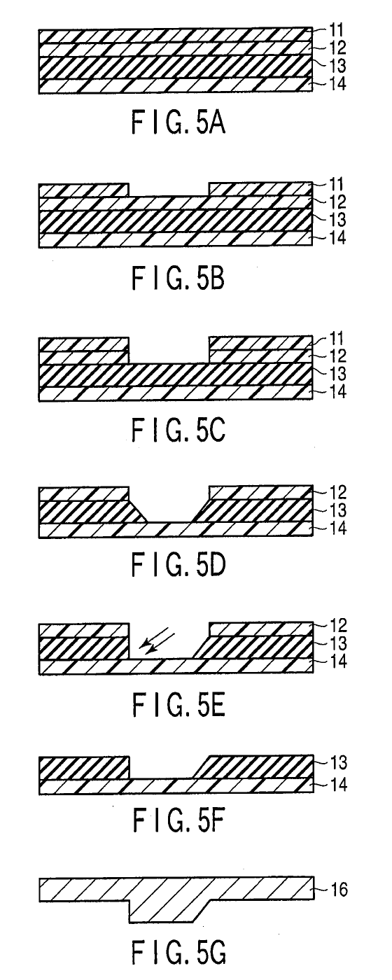

FIGS. 5A to 5G show a method for producing a second guide stamper 16 used in a method for producing an imprint mold 23 according to the second embodiment.

The processes in FIGS. 5A to 5D are the same as those shown in FIGS. 1A to 1D, respectively, in the method for producing the first guide stamper 15.

As shown in FIG. 5E, one of wall surfaces of a recess formed in a sputter carbon layer 13 is processed and formed into a rectangle, for example. This processing, for example, is performed by inclining a laminate to etch the wall surface to be processed. Thus, a pattern of protrusions and recesses, in which angles of the opposite wall surfaces in the recess of the sputter carbon layer 13 are different, is formed.

FIGS. 5F and 5G are the same as the processes shown in FIGS. 1E and 1F, respectively, in the method for producing the first guide stamper 15.

The second guide stamper 16, in which the angles of the right and left wall surfaces of the recess are different from each other, is formed by the producing method of the embodiment shown in FIGS. 5A to 5G, as shown in FIG. 5G.

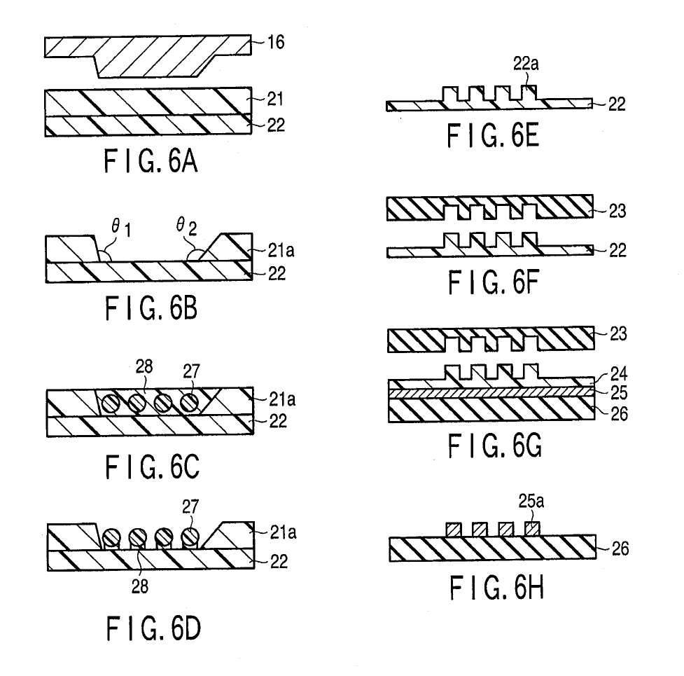

FIGS. 6A to 6H show the method for producing the imprint mold 23 and the method for producing the magnetic recording medium according to the second embodiment, formed by using the second guide stamper 16.

The processes in FIGS. 6A to 6H are the same as FIGS. 2A to 2H, respectively, in the producing method according to the first embodiment.

However, as shown in FIG. 6B, an angle θ₁ between a first wall surface and an exposed surface of a silicon substrate 22 is different from an angle θ₂ between a second wall surface and the exposed surface of the silicon substrate 22; in FIG. 6B, θ₂ is 120° or more and 131° or less while θ₁ is an angle approximate to a right angle. Thus, if one angle satisfies the condition of being 131° or less, preferably 120° or more and 131° or less, even though the other angle does not satisfy the condition, an exact dot pattern may be formed in the same manner as the imprint mold 23 or the magnetic recording medium according to the first embodiment.

### Example 1

A first guide stamper 15 for producing a guide was produced by a method shown in FIGS. 1A to 1F.

As shown in FIG. 1A, a 40-nm sputter carbon layer and a 5-nm silicon sputter film were formed on a silicon substrate 14. An electron beam resist 11 (ZEP manufactured by ZEON CORPORATION) was applied thereon.

As shown in FIG. 1B, electron beam drawing and development were performed for the electron beam resist 11 to form a desired guide pattern.

As shown in FIG. 1C, the silicon hard mask 12 was etched by using the electron beam resist 11 with the pattern formed as a mask with the use of CF₄ gas. Thus, the pattern was transferred to the silicon hard mask 12.

As shown in FIG. 1D, the sputter carbon layer 13 was processed by Ar ion milling with the use of the silicon hard mask 12 with the pattern formed as a mask. Thus, a groove having a taper at an angle of 120° was produced.

As shown in FIG. 1E, the silicon mask 12 remaining on the sputter carbon layer 13 was removed by etching with the use of CF₄ gas.

As shown in FIG. 1F, the first guide stamper 15 in which edges on both sides of a protrusion were 120° was produced by nickel electroforming with the use of the guide pattern formed in the sputter carbon layer 13 as a mold.

### Modification Example 1

A second guide stamper 16 for producing a guide was produced by a method shown in FIGS. 5A to 5G.

The processes in FIGS. 5A to 5D were performed in the same manner as the processes in FIGS. 1A to 1D of Example 1 to form a groove, in which angles of both tapers were 120°, in a sputter carbon layer 13.

As shown in FIG. 5E, the angle of one taper was made into 105° by etching while inclining a substrate angle.

As shown in FIG. 5F, a silicon mask 12 remaining on the sputter carbon layer 13 was removed by etching with the use of CF₄ gas.

As shown in FIG. 5G, the second guide stamper 16 in which an edge on one side of a protrusion was 120° and an edge on the other side was 105° was produced by nickel electroforming with the use of a guide pattern formed in the sputter carbon layer 13 as a mold.

### Example 2

A self-assembling pattern was formed by a method shown in FIGS. 2A to 2D on a silicon substrate 22 with a guide 21a formed.

As shown in FIG. 2A, an imprint resist 21 was applied on the silicon substrate 22.

As shown in FIG. 2B, a first guide stamper 15 produced in Example 1 was pressed against the imprint resist 21 to transfer a pattern of protrusions and recesses. When a width of a bottom of a formed recess was measured at a plurality of points, dispersion was observed in the range of 85 nm to 93 nm.

As shown in FIGS. 2C and 2D, a polystyrene-polydimethylsiloxane diblock copolymer (PS-PDMS, molecular weight of PS: 11700, molecular weight of PDMS: 2900) solution was applied in a produced groove between the guides by spin coating to induce phase separation by subsequently annealing at a temperature of 180° C. and form a sphere 27. When a pitch of the formed sphere 27 was measured at a plurality of sphere intervals, each of the sphere intervals was 17 nm.

### Modification Example 2

A self-assembling pattern was formed by a method shown in FIGS. 6A to 6D on a silicon substrate 22 with a guide 21a formed.

As shown in FIG. 6A, an imprint resist 21 was applied on the silicon substrate 22.

As shown in FIG. 6B, a second guide stamper 16 produced in Modification Example 1 was pressed against the imprint resist 21 to transfer a pattern of protrusions and recesses. When a width of a bottom of a formed recess was measured at a plurality of points, dispersion was observed in the range of 85 nm to 93 nm.

As shown in FIGS. 6C and 6D, a polystyrene-polydimethylsiloxane diblock copolymer (PS-PDMS, molecular weight of PS: 11700, molecular weight of PDMS: 2900) solution was applied in a produced groove between the guides by spin coating to induce phase separation by subsequently annealing at a temperature of 180° C. and form a sphere 27. When a pitch of the formed sphere 27 was measured at a plurality of sphere intervals, each of the sphere intervals was 17 nm.

### Example 3

An imprint mold 23 and a magnetic recording medium were produced by a method shown in FIGS. 2D and 2H.

As shown in FIGS. 2D and 2E, a silicon substrate 22 was etched by using a self-assembling pattern produced in Example 2 as a mask with the use of CF₄ gas. Thus, a pattern in which silicon substrate dots 22a were arrayed at a pitch of 17 nm was formed on a surface of the silicon substrate 22.

As shown in FIG. 2F, the imprint mold 23 was formed by nickel electroforming with the use of the silicon substrate 22 with the pattern formed as a mold.

As shown in FIG. 2G, a desired magnetic recording layer 25 was formed on a glass substrate 26 to further apply an imprint resist 24. The imprint mold 23 was pressed thereon to transfer a dot pattern of the imprint mold 23.

As shown in FIG. 2H, the magnetic recording layer 25 was subjected to milling processing by using the imprint resist 24 with the dot pattern transferred as a milling mask, so that the dot pattern with magnetic dots 25a arrayed was produced on the glass substrate 26.

### Example 4

The influence of an angle θ between a wall surface of a guide 21a and an exposed surface of a silicon substrate 22 on a pitch between spheres 27 and the formation of the spheres 27 on the guide 21a was studied.

The silicon substrate 22 with the guide 21a formed thereon, as shown in FIG. 2D, was produced. At this time, 12 kinds in total were produced, such that θ was 105°, 120°, 135° or 150°, and a guide width (a distance of a bottom between the guides) was 85 nm, 88 nm or 93 nm. A self-assembling material was applied to the produced substrate and annealed at a temperature of 180° C. to thereby form the spheres 27.

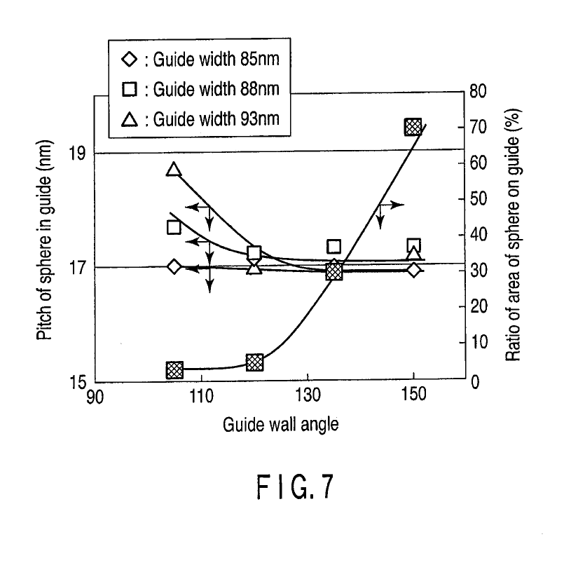

With regard to each substrate, a plurality of pitches between the spheres 27 were measured by using SEM. The results are shown in FIG. 7. In FIG. 7, the horizontal axis signifies the angle θ and the left vertical axis signifies an average value (nm) of the pitches between the spheres 27, and plots common in the guide width are joined by a curve. In addition, with regard to the substrate having a guide width of 85 nm, an area of the spheres 27 formed on the guide 21a was measured by using SEM. The results are shown in FIG. 7. In FIG. 7, the horizontal axis signifies the angle θ and the right vertical axis signifies a ratio of the area in which the spheres 27 were formed on the guide 21a. The ratio was calculated as an area of the spheres 27 to a projected area of an inclined plane of the guide 21a.

Regarding the pitches, three curves different in the guide width separated in the case where θ was small and converged as θ became larger. Specifically, when θ was 105°, the pitches offered values from 17 nm to 19 nm according to a difference in the guide width. On the other hand, when θ was 120° or more, the pitches were approximately 17 nm regardless of the difference in the guide width. It is understood from this fact that a determination of θ at 120° or more allows the pitches between the spheres to be kept constant even though dispersion is caused in the guide width.

Regarding the area, the area of the spheres formed on the guide 21a increased as θ became larger. Specifically, the ratio was 10% or less at 105° and 120°; on the contrary, the ratio increased abruptly when θ exceeded 120°, and the ratio reached around 30% and 70% at 134° and 150°, respectively. It is understood from this fact that a smaller value of θ more restrains the spheres 27 from being formed on the guide 21a.

Through a summary of the results with regard to the pitches and the results with regard to the area, it is understood that when θ is in the range of 120° to 135°, even in the case where dispersion is caused in the guide width, the pitches between the spheres may be kept constant and the formation of the spheres on the guide may be restrained at a constant level to induce self organization.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method for producing an imprint mold, comprising:
forming, on a substrate, a plurality of guides comprising a first wall surface and a second wall surface, wherein an angle between at least one of the first and second wall surfaces and an exposed substrate surface is 131° or less;
applying a self-assembling material, which forms a sphere when phase-separated, to a guide groove area defined by the first wall surface, the second wall surface and the substrate surface, and self-assembling the self-assembling material to form a dot pattern;
etching the substrate by using the dot pattern as a mask to transfer the dot pattern; and
forming an imprint mold by using the substrate with the dot pattern transferred as a master mold.

2. The method of claim 1, wherein the angle is 120° or more and 131° or less.

3. The method of claim 1, wherein the angle between the first wall surface and the substrate is approximately the same as the angle between the second wall surface and the substrate.

4. The method of claim 1, wherein one of the angle between the first wall surface and the substrate and the angle between the second wall surface and the substrate is 90° or more and less than 120°.

5. The method of claim 1, wherein the self-assembling material is a polystyrene-polydimethylsiloxane diblock copolymer.

6. A method for producing a magnetic recording medium, comprising:
forming a resist on a magnetic recording layer;
imprinting the resist with an imprint mold produced by the method of claim 1 to transfer the dot pattern;
removing a residue remaining in a recess of the patterned resist; and
etching the magnetic recording layer by using the patterned resist as a mask to transfer the dot pattern.
